(19) United States
(12) Patent Application Publication
(10) Pub. No.: US 2017/0094730 A1
(43) Pub. Date: Mar. 30, 2017

(54) LARGE BILLET ELECTRIC INDUCTION PRE-HEATING FOR A HOT WORKING PROCESS

(71) Applicants: John Justin MORTIMER, Genesee, WI (US); Andrew Leo BERNHARD, Greenfield, WI (US)

(72) Inventors: John Justin MORTIMER, Genesee, WI (US); Andrew Leo BERNHARD, Greenfield, WI (US)

(21) Appl. No.: 15/275,418

(22) Filed: Sep. 25, 2016

Related U.S. Application Data
(60) Provisional application No. 62/232,857, filed on Sep. 25, 2015.

(51) Int. Cl. H05B 6/34; H05B 6/06; H05B 6/32

(52) U.S. Cl. CPC H05B 6/34; H05B 6/32; H05B 6/06

(57) ABSTRACT

A process for electric induction heating of large billets to a tapered cross sectional heating profile by inductively scan heating the axial circumference of the large billet with a single induction coil prior to hot working the large billet in an extrusion or forging process is provided.

### CROSS REFERENCE TO RELATED APPLICATIONS

This application claims the benefit of U.S. Provisional Application No. 62/232,857, filed Sep. 25, 2015, which is hereby incorporated by reference in its entirety.

### FIELD OF THE INVENTION

The present invention relates to apparatus for, and method of, electric induction heating large billets through the cross section of the billet to a tapered heating profile along the axial length of the billet prior to a process of extruding or forging the billet into an article of manufacture.

### BACKGROUND OF THE INVENTION

A preheated billet is used in an extrusion process where the preheated billet is forced through a die to obtain an article of manufacture. Similarly in a forging process a preheated billet can be forged into an article of manufacture. An extrusion or a forging process is referred to herein as a hot working process.

Pre-heating large billets for a hot working process requires sufficient heating throughout the cross sectional mass of the large billet to the center of the billet along the axial length of the billet for satisfactorily use in a hot working process.

One prior art method for creating a tapered axial temperature profile is to heat the entire billet and then spray water on it to cool it back down to give a tapered temperature profile. This method is referred to as taper quenching and is described in U.S. Pat. No. 5,325,694 A. The tapered quenching process disclosed in U.S. Pat. No. 5,325,694 A results in wasted energy. In extrusion processes the leading (hot) end of the billet that is inserted into the extrusion apparatus has a higher cross sectional temperature than at the opposing trailing (cooler) end of the billet to allow the heat of friction to heat the trailing end and to keep the extrusion die at a constant temperature. For example a large aluminum billet could require a pre-extrusion cross sectional temperature at the trailing end of 350° C. and a pre-extrusion cross sectional temperature at the leading end of 500° C. The hot end of the billet goes into the extrusion die first and the cold end trails so that the heat of friction from extruding through the die will keep the temperature at the die around 500° C. for an aluminum billet.

Another prior art method of creating a less than linear tapered axial temperature profile for a hot working process is to statically heat a large billet within multiple solenoidal induction coils with each coil connected to a separate power supply along the axial length Aₓ of the large billet to achieve a stepped billet cross sectional temperature difference of ΔT between coils as shown in FIG. 1 that can cause problems in the subsequent extrusion process.

In the field of electric induction heat treatment, scan induction heat treatment of workpieces as disclosed, for example, in U.S. Pat. No. 7,291,817 B2, is performed with workpieces having a high ratio of axial length to cross sectional diameters along the axial length of the workpiece, such as a camshaft, to surface (case) harden the workpiece and not to heat throughout the cross sectional mass of a workpiece to its center.

It is one object of the present invention to reduce or eliminate the temperature differences along the length of a large billet resulting from the multi-coil induction heating process described above and achieve a smooth linear (tapered) temperature profile throughout the cross sectional mass along the axial length of a large billet for a hot working process.

It is another object of the present invention to provide a method of electric induction heating of a large billet through its entire cross section and axial length prior to entering an extruding or forging apparatus by passing (moving) the large billet through a single induction coil at a variable speed while varying the induced power applied to the single induction coil and supplied by a single power supply, if necessary, to achieve a particular cross sectional heating profile in the large billet.

These and other objects of the invention are set forth in this specification.

### BRIEF SUMMARY OF THE INVENTION

In one aspect the present invention is a process and apparatus for electric induction heating of large billets to a tapered cross sectional heating profile along the axial lengths of the billets by inductively scan heating along the axial circumferential length of the large billet with a single induction coil prior to hot working the large billet in an extrusion or forging process is provided.

In another aspect the present invention is an apparatus for and method of electric induction heating of a large billet through its entire cross section along its axial length prior to entering an extruding or forging apparatus by passing the large billet through a single induction coil connected to a single power supply with variation of the speed of the large billet moving through the single induction coil and, if necessary, variation in the induced power applied to the large billet moving through the single induction coil as required to result in a desired cross sectional temperature profile along the axial length of the large billet. Optionally a flux extender can be provided at the leading end of the large billet as the billet passes through the single induction coil.

The above and other aspects of the invention are set forth in this specification and the appended claims.

### BRIEF DESCRIPTION OF THE DRAWINGS

The appended drawings, as briefly summarized below, are provided for exemplary understanding of the invention, and do not limit the invention as further set forth herein.

FIG. 1 illustrates a prior art stepped large billet cross sectional induction heating profile achieved along the axial length of the large billet when statically heated within multiple solenoidal induction coils with each coil connected to a separate power supply, in contrast to the present invention which uses a single power supply and induction coil with a scanning type of movement to achieve a smooth heating profile along the axial length of the billet.

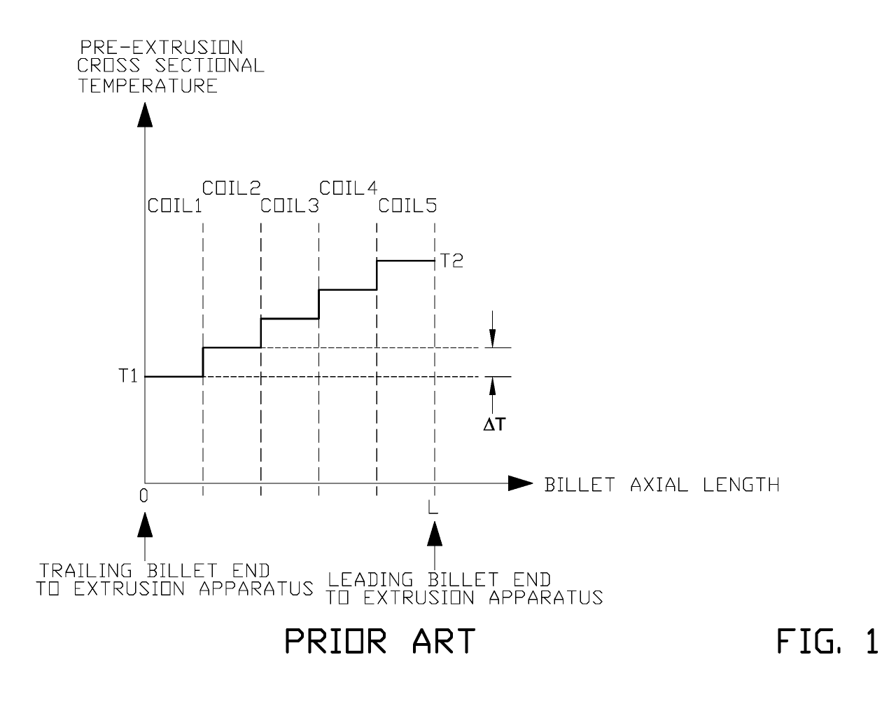

FIG. 2(a) through FIG. 2(d) is a simplified diagrammatic partial cross sectional view of an apparatus used for large billet pre-extrusion electric induction heating of the present invention.

FIG. 3(a) is a graph of a large billet pre-extrusion electric induction heating process of the present invention illustrating a smooth linear (tapered) heating profile achieved in a large billet identified in cross section above the graph.

FIG. 3(b) is an elevational view of the leading end of a large billet showing optional three radial billet thermocouples inserted into the leading end of the billet.

FIG. 4 is a block diagram of one example of a large billet heating process control system for a billet heating process of the present invention.

### DETAILED DESCRIPTION OF THE INVENTION

There is shown in the figures one embodiment of a method of electric induction heating a large billet to a tapered cross sectional heating profile along its axial length Aₓ prior to immediately hot working the billet in an extrusion or forging process. The term “large billet” is used herein to describe billets with a cross sectional dimension (usually a cross sectional diameter) of at least 3.5 inches and where the ratio of the billet's cross sectional dimension to length is at most 3:5.

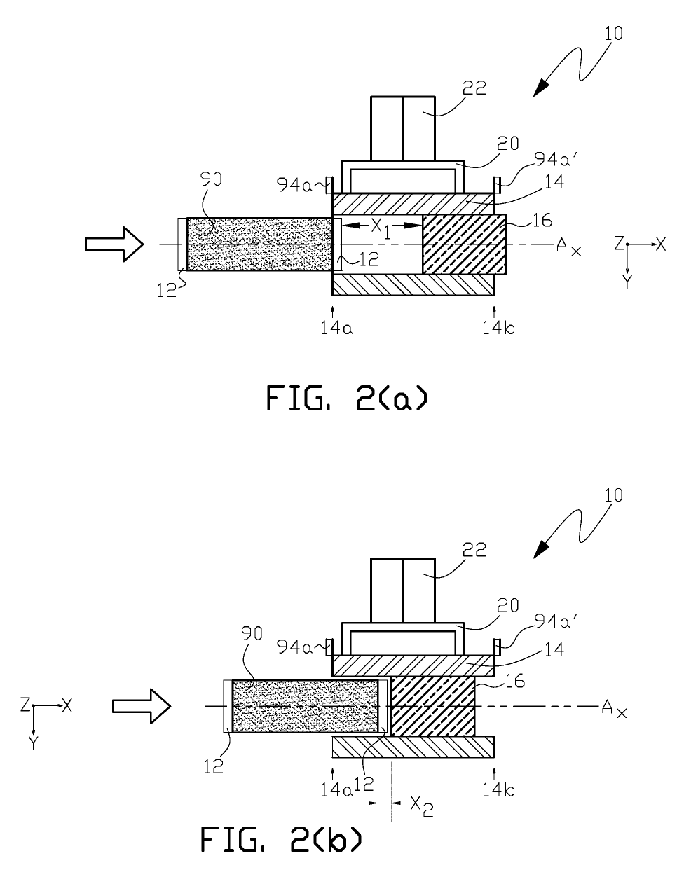

In FIG. 2(a) a large billet 90 is shown at an initial axial entry position to billet solenoidal induction heating coil 14. Large billet 90 is loaded onto a zero-friction billet handling assembly 12 that lifts and holds billet 90 only at the billet's opposing ends for entry into heating coil 14. The zero-friction billet handling assembly can be, for example, a BANYARD® zero-friction billet handling system available from Inductotherm Heating & Welding Ltd (Baskingstoke, England). With the zero-friction billet handling assembly the radial surface of the billet makes no contact with any part of the billet heating apparatus, including the induction heating coil, thus preserving the surface finish of the billet after heating is completed.

In some embodiments of the invention the zero-friction billet handling assembly includes billet rotational apparatus for rotating the billet during at least a portion of the induction heating process of the present invention to promote circumferential temperature uniformity.

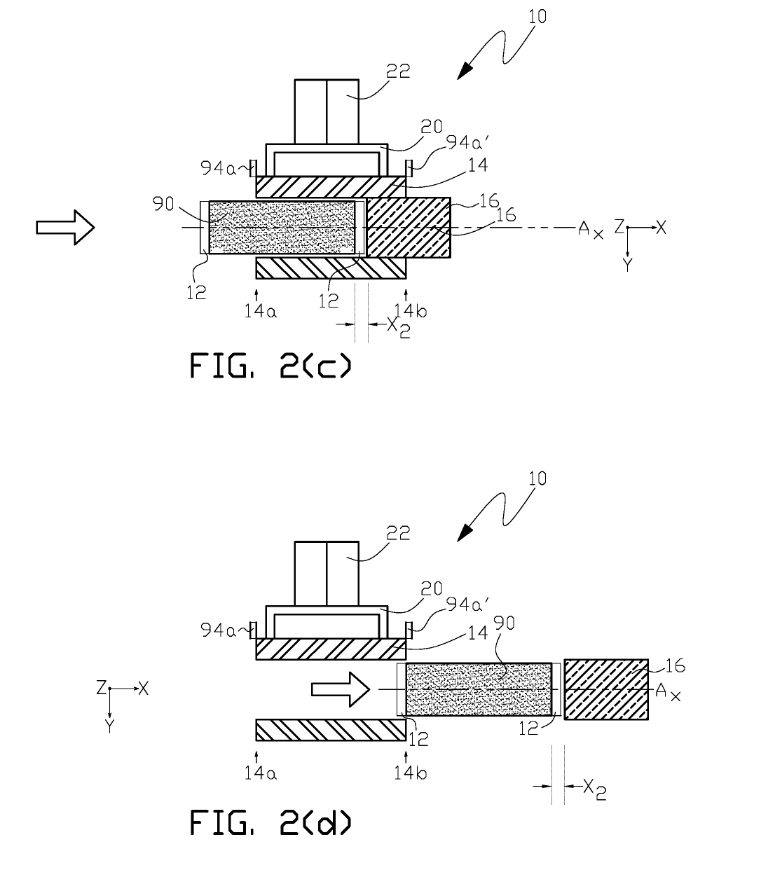

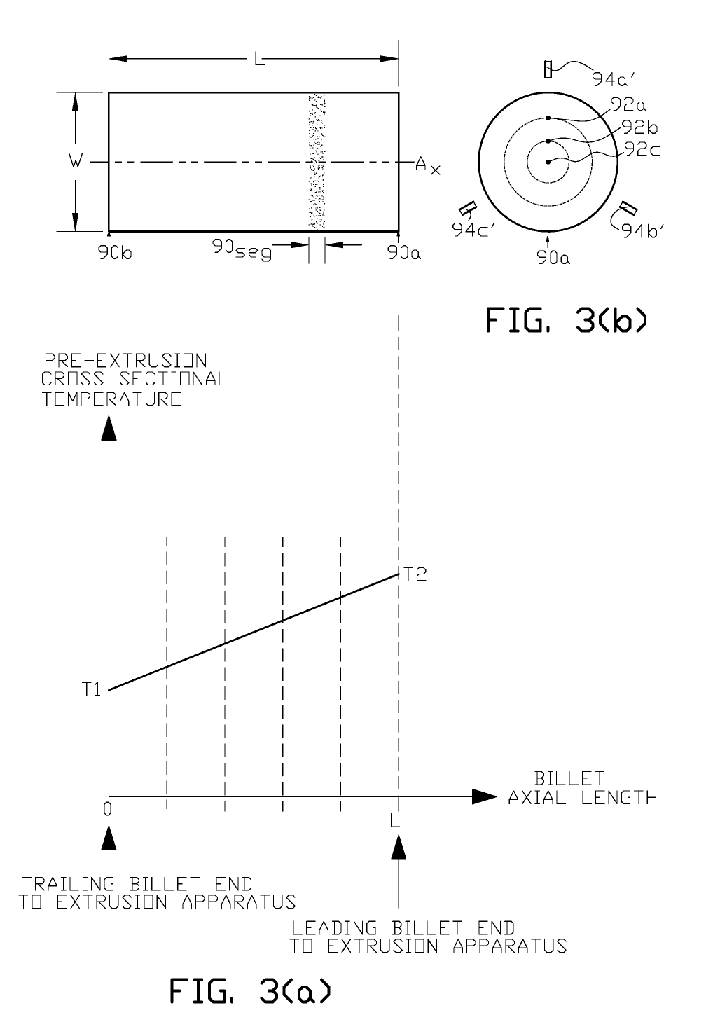

In some embodiments of the invention flux extender 16 can be provided at a fixed or a variable position from the axial leading end 90a (identified in FIG. 3(a)) of large billet 90 for at least a portion of an induction heating process of the present invention. For example, as illustrated for one embodiment of the present invention in FIG. 2(a) through FIG. 2(d), when billet 90 is at the initial coil entry position in FIG. 2(a) flux extender 16 is at a distance X₁ from the axial leading end of the large billet. In FIG. 2(b) when billet 90 is approximately one-quarter of its axial length within coil 14, flux extender 16 is at a smaller distance X₂ from the axial leading end of the large billet and remains at this smaller distance as billet 90 proceeds to approximately three-quarters of its axial length within coil 14 as shown in FIG. 2(c), and then at an initial axial exit position where the entire billet is outside of heating coil 14 in FIG. 2(d). Optional flux extender 16 is formed from an electromagnetically conductive material and is used to extend magnetic flux generated by alternating current flow in coil 14 beyond the leading axial end 90a of billet 90 to control the induced eddy current heating along the axial length of the billet. The flux extender can be mounted on a flux extender transport apparatus that provides variable positioning of the flux extender from the axial leading end of the large billet independent of movement of the billet for at least a portion of an induction heating process of the present invention. In some embodiments of the invention the flux extender remains at a fixed distance from the leading end of the large billet and moves with the billet as it progresses through heating coil 14 during an entire heating process of the present invention.

Large billet induction heating coil 14 comprises a single multi-turn solenoidal coil that is connected at its opposing ends to a single phase alternating current power source 22 that is mounted on platform 20 above the large billet induction heating coil in some embodiments of the invention.

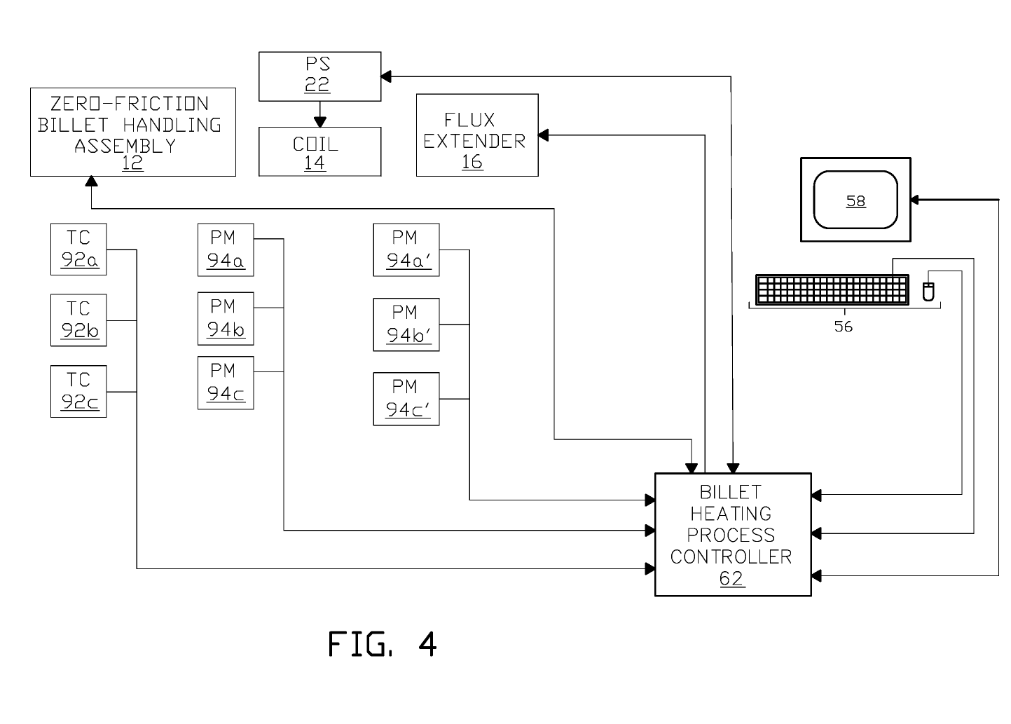

In some embodiments of the invention one or more radial billet thermocouples (TC), such as 92a, 92b and 92c in FIG. 3(b), or other temperature sensing devices, may be inserted into the leading end 90a of the large billet before entry into heating coil 14 to measure the actual cross sectional heating profile of the leading end of the billet before start of a billet heating process of the present invention. In some embodiments of the invention the temperatures measured by the radial billet thermocouples can be inputted to a large billet heating process controller 62 in FIG. 4 that executes a computer program for a large billet cross sectional heating process of the present invention.

Zero-friction billet handling assembly 12 moves loaded large billet 90 into and through heating coil 14 at a processor controlled variable speed to achieve the required cross sectional heating temperature profile along the axial length of the large billet as shown for example in FIG. 3(a).

Optionally in addition to variable speed scan induction heating of the billet, induced power density changes can be made by changing the output power magnitude of power source 22 during the scan induction heating process to achieve the required cross sectional temperature profile in some embodiments of the invention.

In other embodiments of the invention the heating coil alone can be moved at a controlled variable speed along the axial length of a stationary billet loaded on the zero-friction billet handling system, or both the zero-friction billet handling assembly with the billet loaded on it and heating coil can be moved at variable speeds relative to each other.

In FIGS. 2(b), 2(c) and 2(d) large billet 90 loaded on the zero-friction handling system moves progressively further through heating coil 14 in the X-direction and the variable movement speed (velocity) of the billet through the heating coil controls the level of cross sectional temperature heating of the large billet in each billet cross sectional heating segment for example segment 90_{seg} in FIG. 3(a) with a billet scan induction heating process to achieve a cross sectional heating profile of the present invention. If necessary, in addition to billet movement control through the heating coil, induced power density changes can be achieved by changing the output power magnitude of power source 22 during the billet scan induction heating process.

In some embodiments of the invention in addition to variable billet speed control and, if necessary power level control during the billet scan induction heating process, independent movement of flux extender 16 in the X-direction (coincident with the axial length Aₓ of the large billet) may also be used to control the level of cross sectional temperature heating of the large billet during an induction heating process of the present invention.

In some embodiments of the invention multiple cycles of large billet movement through the heating coil (that is, consecutively in the +X and −X directions) may be used to achieve thorough cross sectional heating by a combination of interior cross sectional heat “soaking” and additional eddy current surface heating with each induction heating scan cycle in either the +X or −X directions. One cycle is defined as movement of the large billet in one direction (either +X or −X) through the heating coil. Each cycle need not be a complete passage of the entire axial length of the large billet through the heating coil in one direction as shown in FIG. 2(a) through FIG. 2(d); that is, for example, a single cycle may be completed with billet +X direction movement shown in FIG. 2(a) through FIG. 2(c) and then the next cycle can begin with billet movement reversing to the billet −X direction. Making multiple passes (cycles) of the billet through the heating coil allows full utilization of the power supply output capability without overheating the billet surface. In some embodiments of the invention the heat energy imparted to the billet with each pass is allowed to soak in towards the billet center before more energy is added at the surface with the next pass.

One or more large billet surface scanning pyrometers (PM) for example 94a, 94b and 94c at the entry end and 94a′, 94b′ and 94c′ at the exit end can be provided at heating coil 14 entry end 14a and exit end 14b to verify billet surface temperatures along the axial length of the billet as the billet passes these locations. For example entry axial surface scanning pyrometers 94a, 94b and 94c may be used as input to large billet heating process controller 62 to determine a surface temperature profile prior to starting a large billet taper cross sectional heating process of the present invention and exit axial surface scanning pyrometers 94a′, 94b′ and 94c′ may be used as input to controller 62 after completion of the large billet taper cross sectional heating process to verify that the required heating was achieved and optionally for large billet heating process controller 62 to store the temperature values in an electronic memory device for future reference or input to a large billet heating profile process computer program.

In some embodiments of the invention the large billet can be optionally preheated to a nominal cross sectional heating profile in an oven or other heating apparatus prior to moving the large billet into the billet induction heating. In these embodiments entry axial surface scanning pyrometers 94a, 94b and 94c may be used as input to large billet heating process controller 62 to determine a surface temperature profile of the preheated billet prior to starting a large billet taper cross sectional heating process of the present invention.

In the embodiments on the invention where multiple cycles of large billet movement through the heating coil the entry and/or exit axial surface scanning pyrometers measured temperatures inputted to large billet heating process controller 62 can be used to adjust the process parameters (variable speed; variable power level (if used); or positioning of the flux extender (if used)) during each one of the successive multiple cycles.

In some embodiments of the invention, as shown in FIG. 4, large billet heating process controller 62 can be a suitable computer processing device, for example, a programmable logic controller (PLC) provided as a component of the large billet heating system. Controller 62 executes a large billet cross sectional heating profile computer program that controls: the variable speed of the zero-friction billet handling assembly 12 (with loaded billet) moving the large billet within the coil; the variable level of induced power to heating coil 14 from single power supply 22 if necessary to achieve the desired heating profile; and if used in a particular application, axial movement of the flux extender 16.

As disclosed herein the preferred billet cross sectional heating profile is a linear (tapered) temperature drop tapering linearly from the leading end temperature to the trailing end temperature of the large billet as shown for the example in FIG. 3(a). The large billet heating system is also capable of non-linear tapered billet cross sectional heating in other embodiments of the invention depending upon the particular application and the large billet cross sectional heating profile computer program executed by controller 62.

The tapered cross sectional heating profile of the billet illustrated by the linear curve from T1 to T2 cross sectional temperatures through the axial length of the large billet (from the billet's trailing to the leading end) in FIG. 3(a) is representative of a smooth linear cross sectional heating profile achievable with the scanning type of electric induction heating used in the present invention where in one embodiment of the invention the large billet can move at a variable velocity in either axial direction within the single induction coil while a fixed or variable induced power is supplied by flux coupling with the billet (for eddy current heating) when an alternating current is supplied from a single power supply to the single induction coil. Variable velocity through the single induction coil includes zero velocity in some embodiments of the invention where a movement pause at one or more specific cross sectional regions of the billet within the single induction coil is required to achieve the desired cross sectional heating profile. If variable induced power is used, the variable induced power can include zero induced power in some embodiments of the invention where no power is induced (for eddy current heating) in the billet at one or more specific cross sectional regions of the billet within the single induction coil is required to achieve the desired cross sectional heating profile. In some embodiments of the invention variable induced power includes variable power magnitude and/or variable frequency.

In some embodiments of the invention large billet heating process controller 62 receives input signals from optional radial billet thermocouples 92a, 92b and 92c to modify execution of the cross sectional heating profile program executed by the controller.

Large billet heating process controller 62 provides a billet movement output signal to zero-friction billet handling assembly 12 to control the variable speed (accelerations/decelerations) at which the zero-friction billet handling assembly moves the large billet though the heating coil 14 and an optional billet rotation output signal for rotation of the billet if used in a particular application.

If in a particular application heating coil 14 optionally moves along the axial length of the billet the controller also outputs signals to the heating coil to control movement of the heating coil.

If in a particular application flux extender 16 is used, controller 62 also outputs a flux extender movement output signal to the flux extender's transport apparatus to control a fixed or varying separation distance between the leading end of the billet and the facing end of the flux extender as the billet moves through the heating coil during an induction scan heating process of the present invention.

In some embodiments of the invention human machine interface devices such as display screen 58 and keyboard/mouse 56 are provided for the large billet heating system operator to communicate with large billet heating process controller 62.

In other examples of the invention non-linear cross sectional temperature profiles can be achieved with the large billet heating process controller 62 executing a large billet non-linear cross sectional temperature heating profile process computer program.

While large billet entry into the heating coil is described with the leading end of the billet followed by the trailing end with the leading end being heated to the highest temperature this is not limiting to practice of the present invention.

In the description above, for the purposes of explanation, numerous specific requirements and several specific details have been set forth in order to provide a thorough understanding of the example and embodiments. It will be apparent however, to one skilled in the art, that one or more other examples or embodiments may be practiced without some of these specific details. The particular embodiments described are not provided to limit the invention but to illustrate it.

Reference throughout this specification to “one example or embodiment,” “an example or embodiment,” “one or more examples or embodiments,” or “different example or embodiments,” for example, means that a particular feature may be included in the practice of the invention. In the description various features are sometimes grouped together in a single example, embodiment, figure, or description thereof for the purpose of streamlining the disclosure and aiding in the understanding of various inventive aspects.

The present invention has been described in terms of preferred examples and embodiments. Equivalents, alternatives and modifications, aside from those expressly stated, are possible and within the scope of the invention.

1. A method of taper induction heating of a large billet throughout the cross sectional axial length of the large billet having a leading end and a trailing end prior to extruding the large billet, the method comprising:
loading the large billet on a zero-friction billet handling assembly with the leading end of the large billet oriented for initial axial entry within a single solenoidal induction heating coil; and
moving the large billet on the zero-friction billet handling assembly axially through the single solenoidal induction heating coil from the leading end to the trailing end as required to taper induction heat the large billet with movement of the large billet axially through the single solenoidal induction heating coil controlled at a variable billet scan induction heating velocity while supply alternating current from a single power source to the single solenoidal induction heating coil to inductively heat the large billet throughout the cross sectional axial length to a tapered cross sectional heating profile.

2. The method of claim 1 further comprising varying the output power magnitude from the single power source to the single solenoidal induction heating coil while moving the large billet on the zero-friction billet handling assembly axially through the single solenoidal induction heating coil.

3. The method of claim 1 further comprising preheating the large billet prior to loading the large billet on the zero-friction handling system.

4. The method of claim 1 further comprising rotating the large billet on the zero-friction billet handing assembly while moving the large billet on the zero-friction billet handling assembly axially through the single solenoidal induction heating coil.

5. The method of claim 1 further comprising positioning a flux extender at a distance from the leading end of the large billet while moving the large billet on the zero-friction billet handling assembly axially through the single solenoidal induction heating coil.

6. The method of claim 1 further comprising:
inserting a plurality of radial billet thermocouples into the leading end of the large billet prior to moving the large billet on the zero-friction billet handling assembly axially through the large billet solenoidal induction heating coil;
measuring a heating process start billet leading end cross sectional temperature profile from output temperatures of the plurality of radial billet thermocouples; and
adjusting the variable billet scan induction heating velocity as the large billet moves through the single solenoidal induction heating coil responsive to the heating process start billet leading end cross sectional temperature profile.

7. The method of claim 1 further comprising measuring a billet entry and/or a billet exit circumferential surface temperature of the large billet as the large billet moves axially through the entry and or the exit of the single solenoidal induction heating coil.

8. The method of claim 1 wherein moving the large billet on the zero-friction billet handling assembly axially through the single solenoidal induction heating coil further comprises moving the large billet through more than a single cycle through the single solenoidal induction heating coil at the variable billet scan induction heating velocity.

9. A method of taper induction heating of a large billet throughout the cross sectional axial length of the large billet having a leading end and a trailing end prior to extruding the large billet, the method comprising:
loading the large billet on a zero-friction billet handling assembly with the leading end of the large billet oriented for initial axial entry within a single solenoidal induction heating coil; and
moving the large billet on the zero-friction billet handling assembly axially through the single solenoidal induction heating coil from the leading end to the trailing end as required to taper induction heat the large billet with movement of the large billet axially through the single solenoidal induction heating coil controlled at a variable billet scan induction heating velocity while supply alternating current from a single power source to the single solenoidal induction heating coil with a varying output power magnitude to inductively heat the large billet throughout the cross sectional axial length to a tapered cross sectional heating profile.

10. The method of claim 9 further comprising rotating the large billet on the zero-friction billet handing assembly while moving the large billet on the zero-friction billet handling assembly axially through the single solenoidal induction heating coil.

11. The method of claim 10 further comprising positioning a flux extender at a distance from the leading end of the large billet while moving the large billet on the zero-friction billet handling assembly axially through the single solenoidal induction heating coil.

12. The method of claim 11 wherein moving the large billet on the zero-friction billet handling assembly axially through the single solenoidal induction heating coil further comprises moving the large billet through more than a single cycle through the single solenoidal induction heating coil at the variable billet scan induction heating velocity.

13. The method of claim 12 further comprising measuring a billet entry and/or a billet exit circumferential surface temperature of the large billet as the large billet moves axially through the entry and or the exit of the single solenoidal induction heating coil.

14. The method of claim 9 further comprising preheating the large billet prior to loading the large billet on the zero-friction handling system.

15. The method of claim 14 further comprising:
inserting a plurality of radial billet thermocouples into the leading end of the large billet prior to moving the large billet on the zero-friction billet handling assembly axially through the large billet solenoidal induction heating coil;
measuring a heating process start billet leading end cross sectional temperature profile from output temperatures of the plurality of radial billet thermocouples; and
adjusting the variable billet scan induction heating velocity as the large billet moves through the single solenoidal induction heating coil responsive to the heating process start billet leading end cross sectional temperature profile.

16. A large billet taper induction heating system for inductively heating a large billet throughout a cross sectional axial length to a tapered cross sectional heating profile, the apparatus comprising:
a single billet solenoidal induction coil;
a zero-friction billet handling assembly for holding the large billet and moving the large billet through the single billet solenoidal induction coil;
a single alternating current power source having an output connected to the single billet solenoidal induction coil; and
a large billet heating process controller for execution of a large billet cross sectional heating process computer program, the controller having a billet movement output signal to the zero-friction billet handling assembly to move the zero-friction billet handling assembly through the single billet solenoidal induction coil at a variable billet scan induction heating velocity and a power command output signal to the single alternating current source to set the power magnitude supplied from the single alternating current power source to the single billet solenoidal induction coil as required by the large billet cross sectional heating process computer program to inductively heat the large billet throughout the cross sectional axial length to a tapered cross sectional heating profile.

17. The large billet taper induction heating system of claim 16 wherein the power command output to the single alternating current source sets the power magnitude supplied power magnitude supplied from the single alternating current power source to the single billet solenoidal induction coil at a variable power magnitude level.

18. The large billet taper induction heating system of claim 16 further comprising a flux extender.

19. The large billet taper induction heating system of claim 16 further comprising a billet rotation output signal from the large billet heating process controller to the billet rotational apparatus to rotate the large billet for at least a portion of the induction heating process.

20. The large billet taper induction heating system of claim 16 further comprising one or more large billet surface scanning pyrometers at the entry end and the exit end of the single billet solenoidal induction coil.
